(19) United States
(12) Patent Application Publication
(10) Pub. No.: US 2010/0028647 A1
(43) Pub. Date: Feb. 4, 2010

(54) Easily millable cad blocks of polymer foam which can be burned out and their use

(75) Inventor: Harald Burke, Frastanz (AU)

Correspondence Address: Friedrich Kueffner, Suite 910, 317 Madison Avenue, New York, NY, 10017, US

(73) Assignee: Ivoclar Vivadent AG

(21) Appl. No.: 12/462,138

(22) Filed: Jul. 29, 2009

(30) Foreign Application Priority Data
Jul. 29, 2008 (DE) 20 2008 008 805.4
Jan. 21, 2009 (DE) 20 2009 000 043.5

(51) Int. Cl. B32B 3/26

(52) U.S. Cl. 428/304.4

(57) ABSTRACT

Polymer blocks for use in the pressing technique, which include a polymer foam and use of the polymer blocks for the production of dental restorations or restoration parts by pressing. The polymer block may be selected from the group consisting of polystyrene, polymethyl methacrylate, polyurethane, phenol- or urea-formaldehyde resins, polyethylene, polypropylene and styrene-acrylonitrile copolymers.

### BACKGROUND OF THE INVENTION

1. Field of the Invention

The present invention relates to a material particularly suitable for models which can be completely burned out and are produced by a CAD/CAM process, and also the use of this material for producing dental restorations or restoration parts by pressing.

2. Description of the Related Art

In the pressing of glasses and glass-ceramics, a technology which was introduced by Ivoclar Vivadent AG, Schaan, Liechtenstein under the name Empress® and has become established in dental technology for over 20 years, a model for a restoration (inlay, onlay, crown, bridge, veneer, abutment, etc.) is usually modeled in wax by hand. This wax part is embedded in a refractory casting composition (embedding composition). During the subsequent preheating process, the casting composition cures and the wax part burns out without leaving a residue. The viscous, softened glass-ceramic composition is then pressed under pressure into the remaining hollow space. In an analogous process, metal can also be melted and poured into the remaining hollow space.

It is likewise possible for only parts of such a restoration, e.g. the aesthetic facing, to be pressed onto an existing framework made of metals, alloys, glass-ceramics or oxide ceramics. For this purpose, the envisaged facing is modeled in wax on the framework and embedded, the wax is subsequently burned out as described above and the facing of glass or a glass-ceramic is pressed into the hollow space.

Restorations are being increasingly modeled on a computer (CAD) and produced by machine (CAM).

A widespread process for production by machine is a subtractive process. The desired workpiece is milled or ground from a solid block.

These machines (e.g. Sirona InLab® or KaVo Everest®) are able to grind dental restorations directly out of ceramics suitable for the grinding process (e.g. zirconium oxide, aluminum oxide or glass-ceramics based on, for example, leucite, leucite-apatite, feldspar or lithium silicate).

However, combining the CAD/CAM process with pressing technology is frequently desired because nonmillable but pressable ceramic materials are to be processed by pressing or metals are to be processed by casting.

Some materials are not suitable for grinding because they are either too brittle and would break or because they are too tough and would cause high tool wear and result in a long machining time. On the other hand, it may be desirable to produce parts of the restoration by the CAD/CAM technique and other parts by the pressing technique in order to combine the advantages of the one technique with the advantages of the other technique.

The above-described process for producing restorations or parts thereof by the two processes of, firstly, hot pressing of glass-ceramics or glasses and, secondly, CAD/CAM processes independently, have their advantages but also limitations in terms of the possible applications.

Thus, the CAD/CAM technique has, inter alia, the advantage that it is possible to save time; in addition, the. data are stored so that a restoration can be reproduced if necessary. The pressing technique has the advantage of the greatest accuracy of fit and it is also possible to produce complicated geometries, e.g. undercuts, which would be possible but not practical to produce by grinding.

For example, a glass-ceramic material can be pressed onto a zirconium oxide framework or onto a metal framework in the Empress process. The zirconium oxide framework is usually manufactured by a CAM process since it cannot readily be pressed in the Empress process. The metal framework, on the other hand, can have been cast or milled. In a CAD/CAM process, the data for the complete restoration are then in the best case already available and it is simple to design the desired coating on the computer and mill the second part, viz. the coating, by machine.

To be able to use the materials for the pressing technique, a material which can be burned out completely and is millable can be manufactured by machine. This is temporarily bound to the framework. The composite is then embedded in a known manner in a refractory casting composition. The part which can be burned out and corresponds, for example, to the facing part of the restoration burns out completely while the framework remains unchanged. In the subsequent pressing process, the hollow space formed is filled with pressing ceramic. After removal from the embedding composition, a restoration composed of a high-strength framework and an aesthetic coating is obtained.

A special block is available for this purpose, e.g. from VITA. The block is named, corresponding to its intended use, CAD-Waxx for InLab®, because wax is ideally suited to the burn-out technique.

However, wax is not very suitable for machining since, firstly, it is smeared over the grinding tools and, secondly, it breaks easily.

The CAD-Waxx block is therefore made of a solid polymer (PMMA) which can be burned out completely.

This solid polymer material has a number of sometimes serious disadvantages:
It can be machined only very slowly since it becomes ductile when a large amount of heat is produced and then tends to be smeared over the grinding tools.
The grinding dust formed quickly blocks the cooling water filters.
After embedding in refractory embedding composition, heat is produced by a chemical reaction (setting reaction of the embedding composition). Since the thermal expansion of the polymer is greater than the thermal expansion resulting from the setting reaction of the embedding composition, compressive stresses act on the embedding composition. These stresses can lead to cracks in the embedding composition. It is therefore not possible to embed any thick-walled objects.

For the purposes of the present invention, the acronyms CAD and CAM have the meanings given in, for example, Römpp Chemie Lexikon, 9th Edition, Volume 1, 1989, pages 541 and 565. Since the CAD/CAM terminology is also widely known in technical circles, further and more precise embodiments will be adequately known to those skilled in the art.

### SUMMARY OF THE INVENTION

It is an object of the present invention to provide a material or a workpiece, in particular for use in the pressing technique, which no longer has the abovementioned disadvantages.

This object is achieved by a polymer block for use in the pressing technique, which includes a polymer foam.

The various features of novelty which characterize the invention are pointed out with particularity in the claims annexed to and forming a part of the disclosure.

### DETAILED DESCRIPTION OF THE INVENTION

The abovementioned disadvantages can surprisingly be avoided when a polymer foam is used in place of a solid polymer. Polymer foams are materials having a cellular structure, among which a distinction is made between open-pored and closed-pored polymer foams. Hard and tough polymer foams (composed of polystyrene, polymethyl methacrylates, styrene-acrylonitrile copolymers, polyethylene, polypropylene or polyurethane) and hard and brittle polymer foams (composed of polyurethane, phenol- or urea-formaldehyde resins) have been found to be particularly advantageous.

Very particular preference is given to foamed polystyrene.

Closed-pored polymer foams having a foam density of less than 130 kg/m³ are particularly preferred and very particular preference is given to materials having a foam density of less than 80 kg/m³, as long as they meet the following conditions:
The material is dimensionally stable. It has a dimensional stability of better than 0.2%. Dimensionally stable means that the actual dimensions of the workpiece after machining are within a deviation of 0.2% from the prescribed nominal value, i.e. the permissible dimensional deviation from the prescribed value. The dimensional stability is a term for the geometric resistance of the workpiece to expansion and shrinkage during machining.
The material has a high stiffness, i.e. an E modulus of >5 MPa, in the temperature range from 20° C. to 40° C.
The material has a compressive strength of >100 kPa.
The material is water-resistant. It absorbs not more than 0.2% of water, i.e. there is an increase of 0.2% by weight based on the starting material, during storage for 24 hours at room temperature in water.
To achieve a satisfactory surface quality, microcelled, fine-celled or medium-celled grades are preferably used. Here, microcelled means an average pore diameter of less than 0.3 mm, fine-celled means from 0.3 to 0.5 mm and medium-celled means from 0.5 to 3 mm. According to the invention, average pore diameters of less than 1 mm are preferred, less than 0.5 mm are particularly preferred and from 0.05 to 0.15 mm are very particularly preferred, with each of these being able to be determined by means of an optical microscope.
The material can also be burned out without leaving a residue at temperatures in the range from 750° C. to 900° C. under an air atmosphere.

Examples of suitable polymer foams are Neopor® and Styropor® from BASF and IsoBouw, foamed PE (Plastazote®), PP (Propozote®) and PA (Zotek®) grades from W. Kopp and also Jackocell® from Jackon.

Such a block of polymer foam displays the following advantages:
The shaping speed for a block of XPS (extrusion-foamed polystyrene) is very high (15 minutes for a four-membered model bridge), up to four times as fast as in the case of existing material (about one hour for the same model bridge using a CAD-Waxx from VITA) and limited only by the maximum speed of the shaping machine.
The generation of heat is negligibly small, the grinding tools do not become loaded and they are subjected to virtually no wear.
Only little grinding dust is formed. The cleaning intervals become significantly longer.
Only a low pressure is exerted on the embedding composition as a result of the thermal expansion of the polymer foams during the setting reaction of the embedding composition. Although polymer foams display the high thermal expansion which is usual for polymers, the air in the closed pores is compressed and only noncritical compression stresses can therefore arise. The dimensions of the embedded objects are therefore not limited.
Burn-out produces smaller amounts of combustion products, which is advantageous from the point of view of the environment or offgas purification; in addition, the risk of deposits of carbon formed (e.g. soot) in regions having small geometries is significantly reduced.

The production of such blocks is very inexpensive, especially since the holders for fastening them in the shaping machines can advantageously likewise be made of inexpensive polymers. While the blocks are advantageously produced from polystyrene, polyurethane, phenol-formaldehyde resins, polymethyl methacrylate, polyethylene, polypropylene or styrene-acrylonitrile copolymer, the holders for clamping the blocks into the CAD/CAM machines are preferably adhesively bonded on and can comprise, for example, a (fiber-reinforced) polyamide, polystyrene, polypropylene or HD polyethylene.

The polymer blocks of the invention are therefore highly suitable for producing models for the pressing of dental restorations or restoration parts.

In this use, the polymer blocks are, in particular, used in such a way that the hollow space for pressing is formed by burning out parts made of the polymer blocks.

Accordingly, particular preference is given to using the polymer blocks of the invention as modeling material for pressing techniques, in particular the Empress® process.

### EXAMPLES

### Example 1

Blocks having dimensions of about 35×14×14 mm³ were produced from conventional Styropor packaging material having an average pore size of 0.5 mm and a plastic holder was adhesively bonded to an end face.

Models for crowns and inlays were milled from blocks produced in this way, embedded in the usual fashion and, after burning out, restorations were produced by pressing-in a glass or a glass-ceramic by the Empress process.

A good accuracy of fits could be achieved using these models, but the surface quality of the pressed restoration was lower than in the case of a solid polymer and considerably lower compared to a wax model. However, since the restoration parts which are produced by the pressing process are given a final aesthetic coating, the greater roughness does not have an adverse effect.

### Example 2

Example 1 was repeated using Jackocell® R M1 having an average pore size of about 0.1 mm as starting material.

It was able to be shown by means of this example that the use of polymer foams having a relatively small pore size makes a significantly improved surface quality of the pressed restoration parts possible.

After removal of the restoration part from the embedding composition, the part was cleaned by sandblasting, polishing and coating with a glazing composition as per the prior art.

### COMPARATIVE EXAMPLE

A four-membered bridge framework was ground from a CAD-WAXX block having the size CW-40 (from Vita, dimensions 14×15×40 mm) using the shaping machine InLab MCXL (from Sirona). The grinding time was 64 minutes.

### Example 3

Blocks having dimensions of 14×15×40 mm were produced from a commercial polystyrene foam having an average pore diameter of 0.2 mm and a plastic holder was affixed by means of hot wax on an end face. The same four-membered bridge framework as in the Comparative Example was ground. The grinding time was only 18 minutes.

Optimization of the grinding strategy would make a further time saving possible.

### Example 4

Blocks having dimensions of 14×15×40 mm were produced from a microcellular (<0.3 mm) extruded polystyrene foam (XPS) and adhesively bonded by means of hot wax to holders. Crowns, inlays and bridge frameworks were ground from blocks produced in this way. The grinding times were in each case very short and were only about 20-30% of the grinding times required for the same models when these were made of CAD-WAXX from Vita. The accuracy of fit of the foam models was checked on model stumps.

The foam models were subsequently embedded in the usual way (embedding composition: PressVest Speed, from Ivoclar) and burned out at a temperature of 850° C. in a preheating furnace. A pressing ceramic (e.max Press LT) was subsequently pressed at a temperature of 920° C. by the Empress process and the accuracy of fit of the objects was checked on the model stump. Very good accuracies of fit were obtained.

While specific embodiments of the invention have been described in detail to illustrate the inventive principles, it will be understood that the invention may be embodied otherwise without departing from such principles.

I claim:

1. A polymer block for use in pressing technique, comprising a polymer foam.

2. The polymer block as claimed in claim 1, wherein the polymer foam is selected from the group consisting of open-pored and closed-pored polymer foams.

3. The polymer block as claimed in claim 1, wherein the polymer foam is selected from the group consisting of polystyrene, polymethyl methacrylate, polyurethane, phenol- or urea-formaldehyde resins, polyethylene, polypropylene and styrene-acrylonitrile copolymers.

4. The polymer block as claimed in claim 1, wherein the polymer foam
has a density of less than 130 kg/m3,
is dimensionally stable,
has a high stiffness in the temperature range from 20° C. to 40° C.,
is water-resistant,
has an average pore diameter of less than 1 mm,
can be burned out without leaving a residue.

5. The polymer block as claimed in claim 1, wherein the polymer foam
has an average pore diameter of less than 0.3 mm.

6. The polymer block as claimed in claim 1, wherein the polymer foam
has an average pore diameter of range from 0.05 to 0.15 mm.

7. The polymer block as claimed in claim 1, comprising a holder attached to the polymer block.

8. A process for the production of dental restorations or restoration parts using polymer blocks comprising polymer foam by pressing.

9. The process as claimed in claim 8, comprising forming the hollow space for pressing by burning out parts made of the polymer blocks.
